(19) United States
(12) Patent Application Publication
(10) Pub. No.: US 2014/0250762 A1
(43) Pub. Date: Sep. 11, 2014

(54) Line guide for fishing pole

(71) Applicant: David L. Buchstein, Vernon (CA)

(72) Inventor: David L. Buchstein, Vernon (CA)

(21) Appl. No.: 13/792,060

(22) Filed: Mar. 9, 2013

(51) Int. Cl. A01K 87/04

(52) U.S. Cl. CPC A01K 87/04
USPC 43/24

(57) ABSTRACT

Disclosed is a side-loading line guide for a fishing pole. The side-loading line guide allows fishing line loaded through the side of the line-eye, and not just by threading the line through the center of the line guide-eye. The line guide has at least one foot for attaching the side-loading line guide to a fishing pole or to a pole tip. The line-eye of the guide is a split ring with the adjacent turns pressed substantially flat together. The line-eye is connected to the foot (or feet) of the guide by a mounting means such as is typical and known in the field.

### FIELD OF THE INVENTION

The present invention is in the field of fishing and the catching of fish (Class 43), and relates to an apparatus for hooking or gathering fish (subclass 4). Specifically, the invention relates to fishing rods and attachments therefor (subclass 18.1). More specifically, the present invention relates to line guides or tips or guiding fishing line as it moves along the fishing-rod (subclass 24).

### SUMMARY OF THE INVENTION

The present invention is a side-loading line guide for a fishing pole. The present side-loading line guide is for use on a fishing pole, to retain and guide the fishing line from the line spool or reel along the length of one side of the pole and off the tip of the pole. In an exemplary embodiment, the line guide has a line-eye that is coiled-ring much like a key-ring that has been shortened by half a coil. The coiled-ring line-eye allows fishing line to be loaded into the line guide without having to thread the bitter end of the fishing line through the center of the line-eye of the guide. On a fishing pole, this means that fishing line does not threaded through each line-eye in series down the length of the fishing pole. The side-loading line guide allows a person to change reels, spools on spinning reels, etc., without the need to cut and re-tie the line.

The present line guide is “side loading” in that the opening split or gap in the line-eye into which the fishing line is inserted is in the side of the perimeter of the upper section of the line-eye, and perpendicular to the length of the fishing rod. The side loading line guide has at least one guide foot for attaching the side-loading line guide to a fishing pole. However, the side loading line guide can also be practiced with two mounting feet. In one embodiment, the line-eye of the present invention has a coiled-ring (typically a metal ring) having about one and a half turns of a helix, with the coils pressed substantially flat together. The coiled-ring line-eye is attached to the foot or feet of the line guide by a mounting means. Mounting means for practice with the present invention are know to and selectable by one of ordinary skill in the art. In combination as described herein, these elements provide a fishing pole line guide that a fishing line can be loaded through the side of the line-eye, and not just by threading the line through the center of the guide-eye.

For fly fishermen who carry assorted rod-ends with them when fishing, the present side-loading line guide presents an advantage because of its improved facility for removing line from or stringing line onto the rod end of a fishing pole. For the off-shore angler, a failed reel or damaged rod can be changed quickly and with ease. In a fishing derby where time is crucial, the present side-loading line guide is much quicker than threading line through conventional guides and tying a hook on again. When storing multiple rods you can reel up all the line avoiding the annoying tangling that occurs when you're ready to go fishing the next time.

### BRIEF DESCRIPTION OF THE DRAWINGS

FIG. 1 is a side view of a double footed side loading line guide of the present invention.

FIG. 2 is a perspective view of a single footed side loading line guide of the present invention.

FIG. 3 is a perspective view of a pole tip or “tip top” side loading line guide of the present invention.

FIG. 4 is a perspective view of an alternative mount for the double footed side loading line guide of the present invention.

FIG. 5 is an end-on view of the line-eye of the side loading line guide of the present invention.

FIG. 6 is a side view of an alternative embodiment of the side loading line guide of the present invention with a separated perspective view of the line-eye.

### DETAILED DESCRIPTION OF THE INVENTION

Referring now to the drawings, the details of preferred embodiments of the present invention are graphically and schematically illustrated. Like elements in the drawings are represented by like numbers, and any similar elements are represented by like numbers with a different lower case letter suffix. It is understood that although most of the figures illustrate a double-footed embodiment of the present side-loading line guide for a fishing pole, the present invention can be practiced as readily in single-footed embodiments.

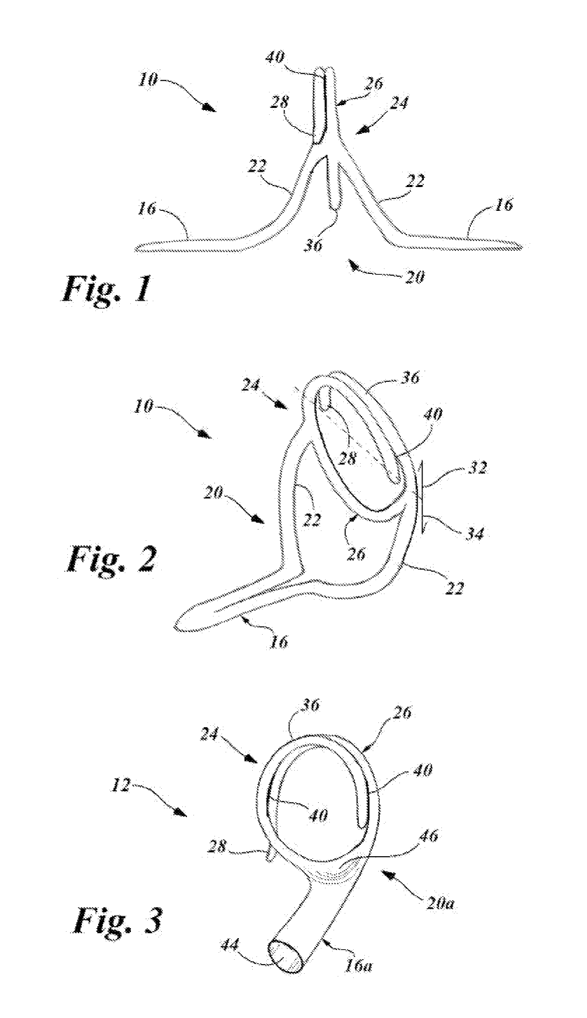

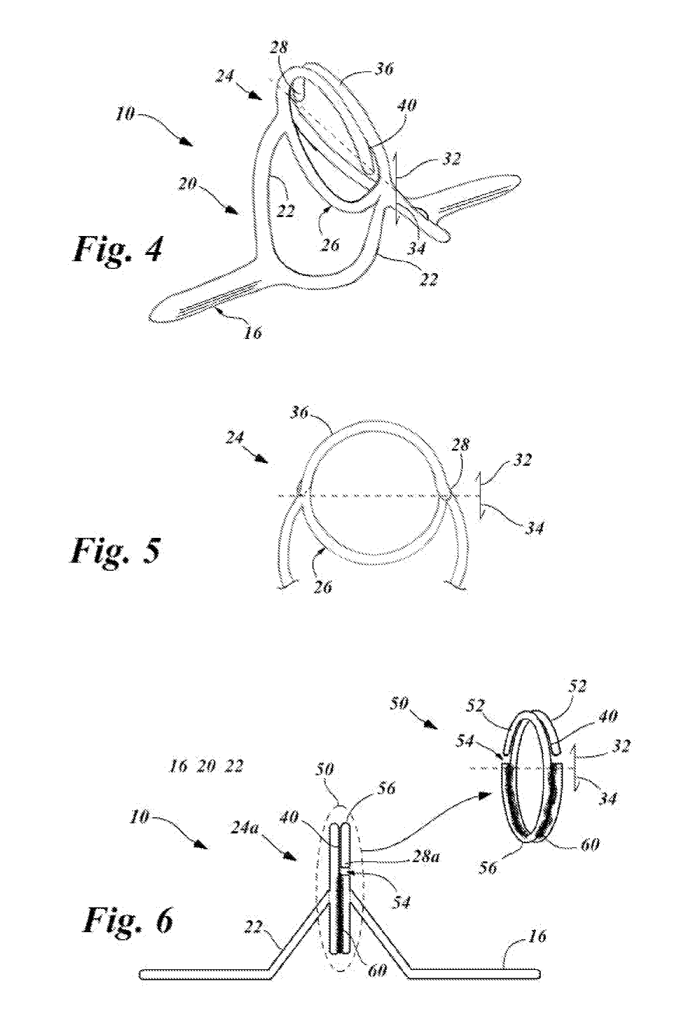

As shown in FIGS. 1-6, the present invention is a side-loading line guide 10 for a fishing pole. In one embodiment, the side-loading line guide 10 has a line-eye 24 through which the fishing line passes that is a coiled-ring line-eye 26. In the embodiments shown in FIGS. 1-5, the coiled-ring line-eye 26 is much like a key-ring that has its coil shortened by half a turn. The coiled-line-eye 26 in this embodiment consists of a split-ring, which is a helical coil having about one and a half turns. The turns of the coil are biased to normally press flat together. The coiled-ring line-eye 26 has an upper section 32 and a lower section 34. In a preferred embodiment, the coil ends 28 of the coiled-ring line-eye 26 are disposed in the upper section 32 of the line-eye 26 and are separated from each other by about 180 degrees of arc along the side/perimeter edge 36 of the line-eye 24. The degree of separation of the coil ends 28 is selectable by the ordinary skilled artisan and can be somewhat more or less that 180 degrees of perimeter arc, in part depending on the material composition of the line-eye 24 and manner in which it is attached to a guide foot 16. The upper section 32 of the coiled-ring line-eye is defined as that section of the line-eye 24 starting proximate the coil ends 28 and distal to the guide foot or feet 16.

In the embodiment illustrated in FIG. 5, the coil ends 28 of the helical coil of coiled-ring line-eye 26 are bent slightly away from the line-eye 24, to help prevent the fishing line from working it's way into the split or slip-space 40 between the coils in the upper section 32 of the line-eye 24.

The side-loading line guide 10 has at least one guide foot 16 for attaching the device 10 to a fishing pole (not shown). See FIG. 3. However, the side loading line guide 10 can also be practiced with two mounting feet 16 as exemplified generally in FIGS. 1-2, 4 & 6. The use of one or more mounting feet 16 to attach a line guide to a fishing rod is known to one of ordinary skill in the art. The specific structural features of the of the guide foot or feet 16 and their point of attachment to the line-eye 24 is not critical as illustrated by the differences in the figures, so long as the utility of the coiled-ring line-eye 26 is maintained (e.g., see FIG. 3).

A support means 20 connects the guide feet 16 to the coiled-ring line-eye 26, generally to the lower-section 34 of line-eye 24. However, the point of attachment of the support means 20 to the line-eye 24 is selectable by the skilled artisan, and can be accomplished in the upper-section of the line-eye 24, so long as the support means 20 does not interfere with the utility of the line-eye 24. In the FIGS. 1-2, 4 and 6, the support means 20 is a pair of legs 22 extending between the coiled-ring line-eye 26 and a guide foot 16. Support means other than structures similar to the legs 22 exemplified in the figures are known to and selectable by one of skill in the art for practice in the present invention. For example, FIG. 3 illustrates an embodiment of the present side-loading line-eye 12 wherein the single guide foot 16a portion is adapted to slip over and closely receive the top end of a fishing rod tip (not shown). In this embodiment, the guide foot 16a is basically has a tapered cylinder portion 44 that receives the rod tip. Also, extending from the tapered cylinder 44 is a flattened extension 46 that protrudes upward from the guide foot 16a portion to provide the structure of the support means 20a to which the coiled-ring line-eye 26 is connected.

Alternatively as illustrated in FIG. 6, the line-eye 24 of the present side loading line guide 10 was accomplished by a structural embodiment different from the helical coil of the coiled-ring 26 described above. The coiled-ring line eye 26 described above is a single helical coil of substantially greater that one turn (i.e., substantially more than 360 degrees). In the embodiment shown in FIG. 6, the line-eye 24a was a split-ring line-eye 50, consisting of a two separate split-rings 52, each of which was a single turn just under 360 degrees of arc, and were substantially flat but had a small through gap 54 in the perimeter edge 56 of each split-ring 52. To accomplish this alternative of a split-ring line-eye 50, two separate split-rings 52 of a single turn each and made of metal were used. The two separate split-rings 52 were stacked flatly adjacent and congruent with each other to initially form the line-eye 24a. The split-rings 52 each had a small ring gap 54 in it, sufficient to allow passage of a desired range fishing line gages. The ring gap 54 of each split-ring 52 was distally separated from the other along the perimeter 56 of the adjacent rings 52 by about 180 degrees of arc. The portion of the perimeter edge 56 between the ring gaps 54 formed the slip-space 58 (the space between the rings 52 through which the fishing line was passed into the interior of the split-ring line-eye 50), and defined the upper section 32 of the line-eye 24a. To finish the line-eye 24a, the remaining portion of the perimeter edge 56 of the stacked and flatly adjacent split-rings 52 was fixed together by a joint 60 of solder. Although in the embodiment illustrated, the adjacent split-rings 52 were fixed together with a solder joint, the skilled artisan knows other ways to join or fix the split-rings 52 together, such as by brazing and welding for metal coils and epoxying or plastic welding for plastic and composite materials. The joined together portion of the perimeter edge 56 formed the lower section 34 of the line-eye 24a. Thus the split-ring line eye 50 was comprised of a first and second single split-ring 52 with the split-rings 52 being fixed to each other along a perimeter edge 56 of the lower section 34 below the ring gaps 54 of the stacked split-rings 52.

The support means 20a for connecting the split-ring line-eye 50 to the guide feet 16 were accomplished in this embodiment in a manner similar to that described above for the coiled-ring line-eye 26.

While the above description contains many specifics, these should not be construed as limitations on the scope of the invention, but rather as exemplifications of one or another preferred embodiment thereof Many other variations are possible, which would be obvious to one skilled in the art. Accordingly, the scope of the invention should be determined by the scope of the appended claims and their equivalents, and not just by the embodiments.

What is claimed is:

1. A side-loading line guide (10) for a fishing pole, the line guide (10) comprising:
at least one guide foot (16) for attaching the side-loading line guide (10) to a fishing pole;
a line-eye (24) consisting of a coiled-ring (26), the coiled-ring (26) being a helical coil having about one and a half turns, with the coils biased to normally press substantially flat together, and the coiled-ring (26) having an upper section (32) including a slip-space (40) in a perimeter edge (36) and a lower section (34); and
a support means (20) connecting the at least one guide foot (16) to the lower section (34) of the coiled-ring line-eye (26), in combination providing said fishing pole line guide (10) that a fishing line can be loaded into through the slip-space (40) in the perimeter edge (36) of the coiled-ring line-eye (26).

2. The side-loading line guide (10) for a fishing pole of claim 1, comprising two feet (16) for attaching the side-loading line guide (10) to the fishing pole.

3. The side-loading line guide (10) for a fishing pole of claim 1, wherein the coiled-ring line-eye (26) has coil ends (28), the coil ends (28) being disposed in the upper section (32) of the coiled-ring line-eye (26) and are separated from each other along a perimeter edge (36) of the line-eye (24).

4. The side-loading line guide (10) for a fishing pole of claim 1, wherein the coiled-ring line-eye (26) has coil ends (28) separated from each other by about 180 degrees of arc along a perimeter edge (36) of the line-eye (24).

5. The side-loading line guide (10) for a fishing pole of claim 1, wherein the helical coil of the line eye (24) has coil-ends (28), which coil-ends (28) are bent slightly away from the coiled-ring line-eye (26).

6. The side-loading line guide (10) for a fishing pole of claim 1, wherein the support means (20) is a pair of legs (22) extending between the coiled-ring line-eye (26) and the at least one guide foot (16).

7. A side-loading line guide (10) for a fishing pole, the line guide (10) comprising:
at least one guide foot (16) for attaching the side-loading line guide (10) to a fishing pole;
a line-eye (24a) consisting of a split-ring line-eye (50) having an upper section (32) and a lower section (34), and having a first individual split-ring (52) and a second individual split-ring (52) with the individual split rings (52) each having a ring gap (54), and the individual split-rings (52) placed flatly adjacent each other with the ring gap (54) of each individual split-ring (52) distally separated on a perimeter edge (56) of the upper section (32) of the adjacent individual split-rings (52), and the individual split-rings (52) being fixed to each other by a joint (60) along the perimeter (56) of the lower section (34) of the split-ring line-eye (50), below the ring gap (54) of each individual split-ring (52); and
a support means (20a) connecting the at least one guide foot (16) to the lower section (34) of the split-ring line-eye (50), in combination providing a fishing pole line guide that a fishing line can be loaded through a perimeter edge (56) of the line-eye (24a).

8. The side-loading line guide (10) for a fishing pole of claim 7, wherein the first single and second individual split-rings (52) are metal and the perimeter edge (56) of the individual split-rings (52) in the lower section (34) of the split-ring line-eye (50) are fixed to each other by a metal joining means.

9. The side-loading line guide (10) for a fishing pole of claim 7, wherein the first single and second individual split-rings (52) are metallic and the perimeter edge (56) of the individual split-rings (52) in the lower section (34) of the split-ring line-eye (50) are fixed to each other by a metal joining means selected from the group of metal joining means consisting of: soldering, brazing and welding.

10. The side-loading line guide (10) for a fishing pole of claim 7, wherein the first single and second individual split-rings (52) are non-metallic and the perimeter edge (56) of the individual split-rings (52) in the lower section (34) of the split-ring line-eye (50) are fixed to each other by a joining means selected from the group of not metal joining means consisting of: gluing, epoxying and plastic welding.

11. The side-loading line guide (10) for a fishing pole of claim 7, comprising two feet (16) for attaching the side-loading line guide (10) to the fishing pole.

12. The side-loading line guide (10) for a fishing pole of claim 7, wherein the individual split-rings (52) of the line eye (24a) has ring-ends (28a), which ring-ends (28a) are bent slightly away from the line-eye (24a).

13. A side-loading tip-top line guide (12) for a fishing pole, the line guide (12) comprising:
a guide foot (16a) having a tapered cylinder portion (44) for attaching the side-loading tip-top line guide (12) to a fishing pole;
a line-eye (24) consisting of a coiled-ring line-eye (26), the coiled-ring line-eye (26) being a helical coil having about one and a half turns, with the coils biased to normally press substantially flat together, and the coiled-ring line-eye (26) having an upper section (32) including a slip-space (40) in a perimeter edge (36) and a lower section (34); and
a support means (20a) connecting the guide foot (16a) to the lower section (34) of the coiled-ring line-eye (26), in combination providing said fishing pole tip-top line guide (12) that a fishing line can be loaded into through the slip-space (40) in the perimeter edge (36) of the coiled-ring line-eye (26).

14. The side-loading tip-top line guide (12) for a fishing pole of claim 13, wherein the support means (20a) of the line guide (12) is an extension (46) that protrudes upward from the guide foot (16a) to provide the support means (20a) to which the coiled-ring line-eye (26) is connected.
